(19) United States
(12) Patent Application Publication
(10) Pub. No.: US 2006/0151991 A1
(43) Pub. Date: Jul. 13, 2006

(54) Information carrier band label, especially for use with wine bottles

(76) Inventor: Mikael Torma, Budapest (HU)

Correspondence Address: LADAS & PARRY, 26 WEST 61ST STREET, NEW YORK, NY, 10023, US

(21) Appl. No.: 10/519,038

(22) PCT Filed: Jun. 27, 2003
(86) PCT No.: PCT/HU03/00054

§ 371 Date: Dec. 22, 2004

(30) Foreign Application Priority Data
Jun. 28, 2002 (HU) P0202122

(51) Int. Cl. B42D 15/00

(52) U.S. Cl. 283/101

(57) ABSTRACT

Information carrier band label, especially for use with wine bottles, attached to the cylindrical neck portion (1) of the bottle, which label is made of information carrier sheet of paper or plastic of the similar format. A first end portion (3,3′) is attached to the cylindrical neck portion (1), and a second portion connecting to the first end portion (3,3′) and fixed around the neck portion (1) by a fixing means. The second portion of the band label is capable for carrying information on its both sides, and the band label (2,2′) has two positions, in the first position the band label banded around the neck portion (1) overlapping at least partially itself, beginning at the first end portion (3,3′), while in the second position the second portion is extending freely from the bottle.

The invention is relating to an information carrier band label, especially for use with wine bottles, attached to the cylindrical neck portion of the bottle, which label may be made of information carrier sheet of paper or plastic of the similar format.

Glued labels have already been used on sidewalls and neck portions of bottles. These labels provide information for the consumers in respect of the originated bottles. It is also known such supplemental means which can be separately attached to bottles—for example by hanging on the bottleneck—and can be removed or changed easily. This makes means of this type proper for carrying occasional or additional information.

Bottles, especially wine bottles are commonly closed by a sealing means, most commonly by corks, which are originated by a foil made means, called capsule, which usually get partially or fully removed when one opens the originated bottle. Material of the capsule can be metal or plastic. Without removal of the capsule the cork or equivalent sealing means is not accessible, and the removed capsule can not be readapted to the bottle as original.

The narrow neck portion of a bottle is also frequently a base for adapting labels, conventionally by glue in a fix manner. This kind of label is adapted simultaneously with a capsule in such a manner, that the original capsule and the label are not overlapping.

It is a need for disclosing additional information in respect of a certain bottle i.e. in respect of the filling content, primarily wine, which information may be relevant for the consumers, buyers or guests in a restaurant, bar, etc., who order a certain brand of beverage, wine. The additional information it may be advantageously accessible only when the bottle gets opened, i.e. when the foil capsule is removed. Considering that the neck of the bottle is generally very narrow, having a small diameter, the additional information applicable by traditional labels is too few even if the neck is bound around under the capsule.

Patent specification U.S. Pat. No. 5,924,739 describes a capsule of single layer, non-overlapping cylindrical sleeve, carrying information, typically a message or a code, which is in connection with trading the product, for example wine. This information becomes available by opening the foil capsule. The cylindrical sleeve is made by a basic panel having an end attached onto the other, for example by glue, while the middle portion is surrounding the neck of the bottle. The middle portion includes a linear perforation, along which the capsule can be opened. As a disadvantage this solution is capable for providing information on one side and in a predetermined length only, thus there is not possible to insert easily readable information longer than a code, data or like this. A further disadvantage is that it becomes accessible only after opening the bottle, when the removed part gets finally and irreversibly apart from the bottle.

It is an object of the present invention to provide a new information carrier means for bottles, especially for wine bottles, which is capable for providing a large amount of information, not obstructing, but looking at this is still not making necessary the opening the bottle. At the same time it is an object to make alternatively possible that the information will be visible only after the opening the bottle or a similar procedure. The carrier should not extend over the neck portion of the bottle, and it is also an object to be not removable during transportation and storing.

It is a basic principle of the present invention to insert an information carrier band label in several manners, by using the features of the already present closing capsule, thus providing much larger surface for information than that of the conventional labels, and even in two sided manner. It may be a point of view of positioning that the information on the carrier would be available only after opening the bottle or either before this procedure.

Opening the bottle may happen at restaurants, bars, or similar places by a waiter, when the additional information carried will be available for the guest just before or after the opening procedure of the wine bottle. The first case provides information in a similar way to the conventional labels, with the difference that the availability of information requires a certain action. This action is the “opening” the band label according to the present invention, which may be either a reversible action, with the help of a sticker part, or of an elastic fixing ring. The included information may be of a kind directed to the consumer right after the opening of the bottle. In this respect the character of the information is not to be limited, it may be promotion, advertisement, facts, stories, advice, information of origin, etc.

Accordingly the information carrier band label according to the present invention as described in the opening paragraph further having a first end portion attached to the cylindrical neck portion, and having a second portion connecting to the first end portion and fixed around the neck portion by a fixing means, and the second portion of the band label is capable for carrying information on its both sides, and the band label has two positions, in the first position the band label banded around the neck portion overlapping at least partially itself, beginning at the first end portion, while in the second position the second portion is extending freely from the bottle.

Alternatively an other appropriate band label in its first position the band label banded from its one end around the neck portion in an angle of at least 450°, being under and fixed by the unopened foil capsule, and in its second position the band label is extending freely from the bottle.

The invention will be described with references to the accompanying drawings. The same reference numerals denote the same elements in different drawings.

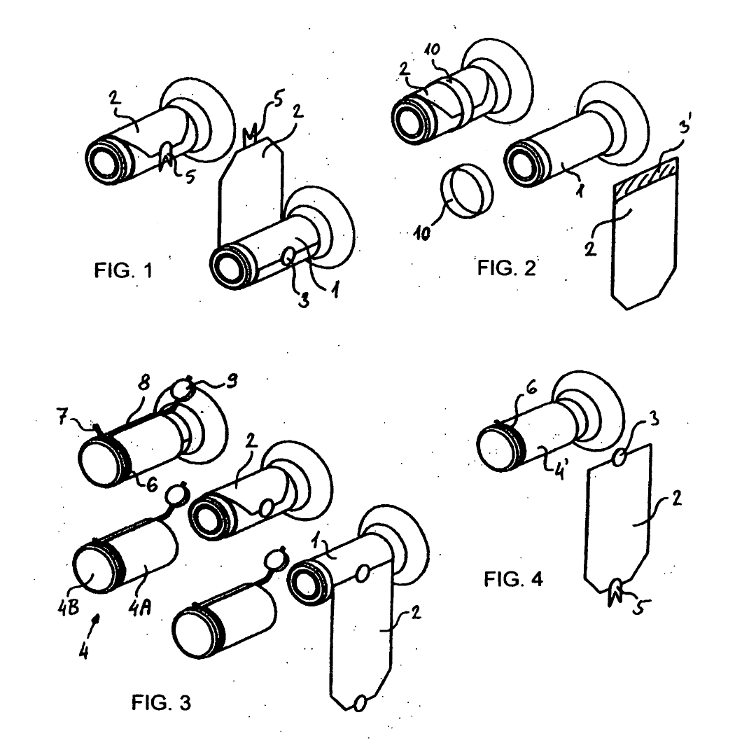

FIG. 1 is a first embodiment of the band label according to the invention, in its first and second positions.

FIG. 2 is a second embodiment of the band label according to the invention, in its first position and prior to attaching to the neck portion of the bottle.

FIG. 3 is a further embodiment of the band label according to the invention, in its first position, with a capsule prior to applying the capsule, and its second position.

FIG. 4 is a further embodiment of the band label according to the invention, with a capsule, prior to applying the band label.

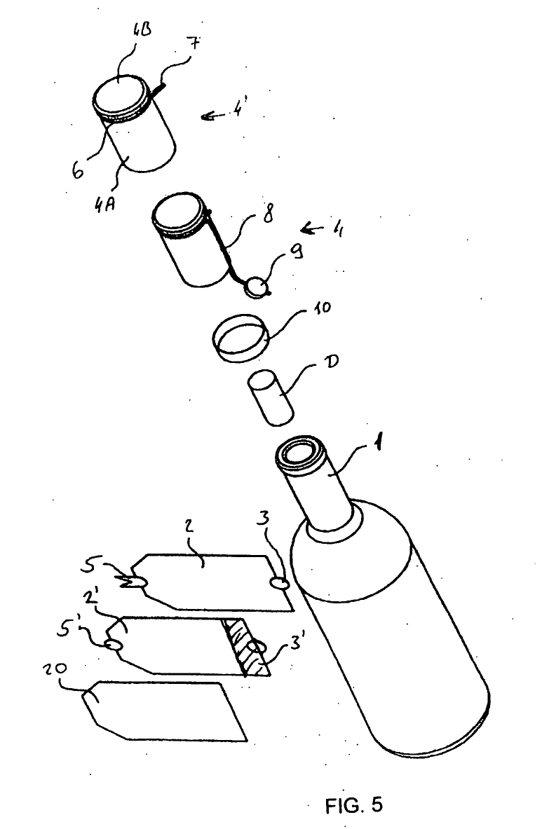

FIG. 5 is parallel illustration of several further embodiment of the band label according to the invention, with different alternative details.

In FIG. 1 a first embodiment of the band label according to the invention can be seen. The label 2 is made of a paper strip of constant width, or plastic of the similar format, having a first end portion 3 attached somehow, for example by glue, to the cylindrical neck portion 1 of the bottle. This first end portion 3 may be relatively small, like the round spot in FIG. 1, but may extend also to a part including almost a full turn around the neck portion 1. A third combined solution is illustrated in FIG. 5 the first end portion 3′ of label 2′ is a rectangular adhesive area with a glued spot. The remaining portion of the band, which has not been in fix attachment, can be rolled onto the first end portion 3 or onto a preceding part of itself, while constituting a roll, and the part which is in connection with the bottle through the first end portion 3 is called further as a second part of the label. This second part is capable to carry information on its both sides. The band label 2 has two positions, in the first position the band label banded around the neck portion 1, rolled overlapping at least partially itself, while in the second position the second portion is extending freely from the bottle. The band label 2 can be fixed in its first position in several ways, basically in two manners. According to one at the end of the second portion opposite to the first end portion 3 a self-adhesive area is provided. Preferably it has a non self-adhesive lug 5 for helping gripping it by fingers. By the help of lug 5 the self-adhesive area can de removed from the neck portion 1 and the same self-adhesive area can be reattached. FIG. 5 shows a further embodiment for a label 2′ with self-adhesive area and a lug 5′.

It is an alternative other solution for fixing label 2 that in rolled first position fixing means is something which concentrically surrounding the neck portion 1 of the bottle. This may be a separate ring 10, and may be made of elastic or non-elastic material. In case of elastic material the ring 10 may be reapplied in several times. The label 2 in this example is attached to the neck portion 1 by a rectangular first end portion 3. It is a appropriate solution of a non-elastic ring 10 when the capsule itself is used for this purpose. In this case the rolled label 2 is partially or fully under the originated capsule 4. As it can be seen in FIG. 3 the foil capsule 4 in addition to the commonly used circular opening strip 6 with a lug 7 for gripping by fingers, also comprises a longitudinal opening strip 8, substantially transversal to the circular one, and having a lug 9. After tearing the circular opening strip 6 and removing the cap part 4B from the bottle the remaining cylindrical part 4A can be removed from the neck portion 1 by tearing the longitudinal opening strip 8. This remaining cylindrical part 4A is keeping the label 2 fixed in its first position, which label 2 preferably may comprise a before mentioned self-adhesive area, as indicated in FIG. 3 by a small circle.

In FIG. 4 an embodiment can be seen where a commonly used known capsule 4′ is applied on the bottle. The band label 2 according to the invention with the first end portion 3 is fixed on the outside of the foil capsule 4′, with the before mentioned self-adhesive area and lug 5.

In FIG. 5 parallel illustration of several alternative details can be seen. Among these in an embodiment the before mentioned first end portion, providing fixing between the neck portion and the label, is missing. In this case a rolled band label 20 is under the capsule 4, covering the sealing means D, where it will be accessible by using said circular opening strip 6 and said longitudinal opening strip 8. In lack of first end portion after opening the capsule 4 the label 20 becomes free of the bottle. Thus the consumer or guest may keep the label 20 as a souvenir.

Among the alternatives of FIG. 5 we can see a fixing ring 10 or a capsule 4 if the label 2 or 2′ is outside of the capsule 4′, the longitudinal opening strip 8 is not necessary, and even could be obstructing the rolled band label 2 or 2′ in the first position. The basic principle of the invention is providing much information for the consumer, and thus the label is efficient if it is rolled on the neck portion 1 of the bottle in much larger length than the perimeter of the neck portion 1. In this way the band label 2 or 2′ in its first position is banded around the neck portion 1 of the bottle in an angle of at least 450°.

The width of the band label 2 or 2′ according to the present invention may be not constant. This may be a trapezoidal or rounded end shaping, or may be a linear changing width along the length. Either constant or non-constant width is the case, it is possible to bring the information carrier band label 2 or 2′ into a rolled first position in a form of an overlapping spiral, by proper adjusting the first portion on the neck portion of the bottle. The invention is not limited to conventional shape wine bottles, but works with any other bottle. Neck portion in this respect should be understood as a portion of a bottle, which has smaller diameter than the maximum. Sealing means may be not only corks but other known means such as twist caps or the like.

1. Information carrier band label, especially for use with wine bottles, attached to the cylindrical neck portion (1) of the bottle, which label is made of information carrier sheet of paper or plastic of the similar format, characterised in that it having a first end portion (3,3′) attached to the cylindrical neck portion (1), and having a second portion connecting to the first end portion (3,3′) and fixed around the neck portion (1) by a fixing means, and the second portion of the band label is capable for carrying information on its both sides, and the band label (2, 2′) has two positions, in the first position the band label banded around the neck portion (1) overlapping at least partially itself, beginning at the first end portion (3,3′), while in the second position the second portion is extending freely from the bottle.

2. The information carrier band label according to claim 1, characterised in that the first end portion (3,3′) attached to the cylindrical neck portion (1) by glue.

3. The information carrier band label according to claim 1, characterised in that the fixing means is a self-adhesive area.

4. The information carrier band label according to claim 3, characterised in that the self adhesive area is provided with a lug (5) for gripping by fingers.

5. The information carrier band label according to claim 1, characterised in that the fixing means is a ring (10) concentrically surrounding the neck portion (1) of the bottle and the band label (2,2′) in its first position.

6. The information carrier band label according to claim 3, characterised in that the ring (10) is made of elastic material.

7. The information carrier band label according to claim 1, characterised in that it is fixed in cooperation with the foil capsule (4,4′) originating the sealing means of the bottle.

8. The information carrier band label according to claim 7, characterised in that the first end portion (3) is fixed on the outside of the foil capsule (4′).

9. The information carrier band label according to claim 7, characterised in that the band label (2,2′) in its first position is fixed under the foil capsule (4).

10. The information carrier band label according to claim 9, characterised in that the foil capsule (4) comprises a circular opening strip (6) and a longitudinal opening strip (8), the circular opening strip (6) dividing the foil capsule (4) into a cylindrical part (4A) and a cap part (4B) where after tearing the circular opening strip (6) the cap part (4B) can be removed from the bottle while the a cylindrical part (4A) remain on the neck portion (1), and after tearing the longitudinal opening strip (8) the a cylindrical part (4A) remained on the neck portion (1) can also be removed, bringing thus the band label (2) into its second position.

11. The information carrier band label according to claim 10, characterised in that the a circular opening strip (6) and the longitudinal opening strip (8) are each provided with a lug (7,9) for gripping by fingers.

12. The information carrier band label according to claim 9, characterised in that the band label (2, 2′) in its first position is surrounded by the unopened foil capsule (4) in partial overlap.

13. The information carrier band label according to claim 1, characterised in that the band label (2,2′) in its first position is banded around the neck portion (1) of the bottle in an angle of at least 450.

14. The information carrier band label according to claim 1, characterised in that the width of the band label (2,2′) is not constant.

15. Information carrier band label, especially for use with wine bottles, attached to the cylindrical neck portion (1) of the bottle, which label is made of information carrier sheet of paper or plastic of the similar format, and which bottle is provided with a foil capsule (4) covering the sealing means (D) of the bottle, characterised in that the band label (20) is capable for carrying information on its both sides, and the band label (20) has two positions, in the first position the band label (20) banded from its one end around the neck portion (1) in an angle of at least 450, being under and fixed by the unopened foil capsule (4), and in the second position the band label (20) is extending freely from the bottle.

16. The information carrier band label according to claim 15, characterised in that the foil capsule (4) comprises a circular opening strip (6) and a longitudinal opening strip (8), the circular opening strip (6) dividing the foil capsule (4) into a cylindrical part (4A) and a cap part (4B) where after tearing the circular opening strip (6) the cap part (4B) can be removed from the bottle while the a cylindrical part (4A) remain on the neck portion (1), and after tearing the longitudinal opening strip (8) the a cylindrical part (4A) remained on the neck portion (1) can also be removed, bringing thus the band label (20) into its second position.
